(19) United States
(12) Patent Application Publication
(10) Pub. No.: US 2011/0226596 A1
(43) Pub. Date: Sep. 22, 2011

(54) ELECTRIC SLIDE SWITCH

(76) Inventor: Guenter LOHR, Leinfelden-Echterdingen (DE)

(21) Appl. No.: 13/050,104

(22) Filed: Mar. 17, 2011

(30) Foreign Application Priority Data
Mar. 17, 2010 (DE) 10 2010 002 948.3

(51) Int. Cl. H01H 3/00

(52) U.S. Cl. 200/329

(57) ABSTRACT

An electric slide switch has at least two contact pins that are secured to a base plate. A contact element supported in sliding fashion is provided for electrically connecting two contact pins. According to the invention, the contact element is situated on a slider that is connected to an actuating component and the actuating component protrudes laterally from the housing.

### CROSS-REFERENCE TO RELATED APPLICATION

This application is based on German Patent Application 10 2010 002 948.3 filed on Mar. 17, 2010.

### BACKGROUND OF THE INVENTION

1. Field of the Invention

The invention relates to an electric slide switch.

2. Description of the Prior Art

There are known electric slide switches, which use at least two contact pins for electrically connecting electrical components for example to a circuit board; the contact pins are secured to a base plate and can be electrically connected to one another by means of a contact element supported in sliding fashion. By means of a slider, the contact element is moved between the contact position and an out-of-contact position. In order to securely keep the slider in the contact position, the contact position simultaneously constitutes a detent-engaged position in which the slider engages in detent fashion with a housing connected to the base plate. The detent engagement usually occurs in all of the switch positions.

The slider is moved by means of an actuating element that is connected to the slider and protrudes from the housing of the slider so that the actuating element can be manually grasped. The actuating element protrudes from the housing either on the side opposite from the contact pins or transversely relative to the movement direction.

### OBJECT AND ADVANTAGES OF THE INVENTION

The object of the invention is to use simple design measures to produce an electric slide switch with a limited overall height. An advantageously secure detent engagement should be provided in the contact position.

The electric slide switch according to the invention can be used for making and breaking an electrical contact, for example on cards or circuit boards. The slide switch includes at least two contact pins that are secured to a base plate and can be electrically connected to each other by means of a contact element that is supported in sliding fashion. The contact element is secured to a slider, which is connected to an actuating component that preferably protrudes from the housing of the slide switch. By means of the actuating component, which functions as an actuator, the slider and therefore also the contact element can be slid in the housing relative to the base plate between a contact position in which the contact pins are electrically connected to each other and an out-of-contact position in which the contact between the contact pins is broken. It is advisable for the contact position to simultaneously constitute a detent-engaged position in which the slider is detent engaged with the base plate or with the housing that is connected to the base plate. This ensures that the contact position is maintained with sufficient reliability, even when acted on by external forces. It is also possible for the out-of-contact position to simultaneously constitute a detent-engaged position in order to prevent the slider and therefore the contact element from being inadvertently moved into the contact position. In particular, the detent engagement is produced with powerful detent engagement forces.

According to another proposal, the movement direction of the slider lies in a line extending through the at least two contact pins; the actuating component protrudes from the housing on the side intersected by the line through the contact pins. This means that the actuating component protrudes laterally from the housing in the movement direction of the slider so that the overall height of the slide switch, measured along the longitudinal axes of the contact pins, is reduced in comparison to embodiments from the prior art in which the actuating component is situated opposite the contact pins. The overall volume is also reduced in comparison to known embodiments that have an actuating component protruding transversely relative to the movement direction since in the embodiment according to the invention, only the axial length of the slide switch is increased due to the actuating component protruding from the end, but the actuating component does not influence the height and width. Thus in the embodiment according to the invention, the overall dimensions are only increased in one spatial direction whereas the overall size in the two other spatial directions is determined solely by the dimensions of the housing and contact pins, but not by the actuating component.

The actuating component or actuator protrudes laterally from at least one end of the housing, at least in one position of the slider. It can be suitable in at least one other position, for the actuating element to be plunged into the housing or to at least brought close enough to the housing that only a narrow section protrudes from the edge of the housing, for example because a stop on the actuating element prevents it from sliding all the way into the housing. For example, the stop is embodied in the form of one or more projections that protrude laterally from the slider or actuating component and strike against the outside of the housing when the actuating component is slid into it, thus preventing the actuating component from sliding farther in.

Basically, it is sufficient if the actuating element, which is to be slid in the movement direction of the slider and has the salve longitudinal axis as the slider, is provided on only one side of the housing. According to another suitable embodiment, two actuating components or actuators are provided at diametrically opposite ends of the housing and protrude laterally beyond the edge the housing and in particular, are firmly coupled to each other. As one actuating component approaches the housing, the opposing actuating component is simultaneously slid out from the housing and vice versa. This embodiment has the advantage of permitting a particularly simple actuation for moving the slide switch between the different contact and out-of-contact positions. Basically, it is sufficient to produce the various positions exclusively by means of a pushing motion that is exerted on either the one or the other actuating component at the opposing ends of the housing. Correspondingly, in lieu of a pushing motion, it is also possible for a pulling motion to be exerted on the actuating component protruding from the housing. In this case, no torques or torsional moments are produced, which could cause the slider to jam in the housing in the embodiments known from the prior art.

According to an advantageous modification, detent engagement elements for producing the detent-engaged position are provided on at least one side of the slider, but preferably on two opposing sides of the slider, and in the detent-engaged position, engage in detent fashion with associated detent engagement elements provided on the housing. Providing detent engagement elements on opposing sides of the slid has the advantage of a uniformly exerted detent engagement action and an increased detent engagement force. On the other hand, providing one or more detent engagement elements on only one side of the slider has the advantage of being small in size. The detent engagement elements are preferably situated in the side region transverse to the movement direction of the slider. The detent engagement forces can be further increased by means of a third set of detent engagement grooves on the top surface of the housing. These forces are supported against the base plate.

The detent engagement elements are preferably embodied in the form of detent engagement springs, which produce a spring force that holds the slider in the detent-engaged position. In this case, the detent engagement springs or otherwise embodied detent engagement elements preferably engage in detent engagement recesses that are provided in the housing; basically, the detent engagement elements can also be embodied for example in the form of detent engagement projections provided on the housing. In addition, it is also possible to provide detent engagement springs that are affixed to the housing and cooperate with detent engagement elements on the slider, which are embodied in the form of detent engagement recesses and detent engagement projections or the like.

The electric slide switch has at least two contact pins that can be electrically connected to each other via the contact element on the slider. According to another suitable embodiment, at least three such contact pins are secured to the base plate of the slide switch while two adjacent respective contact pins are electrically connected to each other via the contact element. The three contact pins are situated in a row; the straight line passing through the contact pins simultaneously constitutes the longitudinal axis of the actuating component and the sliding direction of the slider and actuating component.

According to another suitable embodiment, connecting legs for producing a mechanical connection to another component, in particular for connecting to a circuit board on which electrical and/or electronic units are situated, are formed onto the housing and are in contact with the contact pins of the slide switch. In a preferred embodiment, the contact pins and the connecting legs are situated on the same side of the housing.

The invention will be better understood and further objects and advantages thereof will become more apparent from the ensuing detailed description of preferred embodiments taken in conjunction with the drawings.

### BRIEF DESCRIPTION OF THE DRAWINGS

FIG. 1 is a perspective view of an electric slide switch with actuating components at opposite ends of the housing; the actuating components extend transversely relative to contact pins, which are secured to a base plate,

FIG. 2 is a schematic depiction of three contact pins, two of which are electrically connected to each other via a contact element,

FIG. 3 is an end view of the embodiment according to FIG. 2,

FIG. 4 is a view corresponding to FIG. 3, but with an additional slider to which the contact element is secured,

FIG. 5 shows another embodiment of an electric slide switch, with the slider depicted in a position in which it is slid out toward one end, and

FIG. 6 is an end view of the slide switch according to FIG. 5.

### DESCRIPTION OF THE PREFERRED EMBODIMENTS

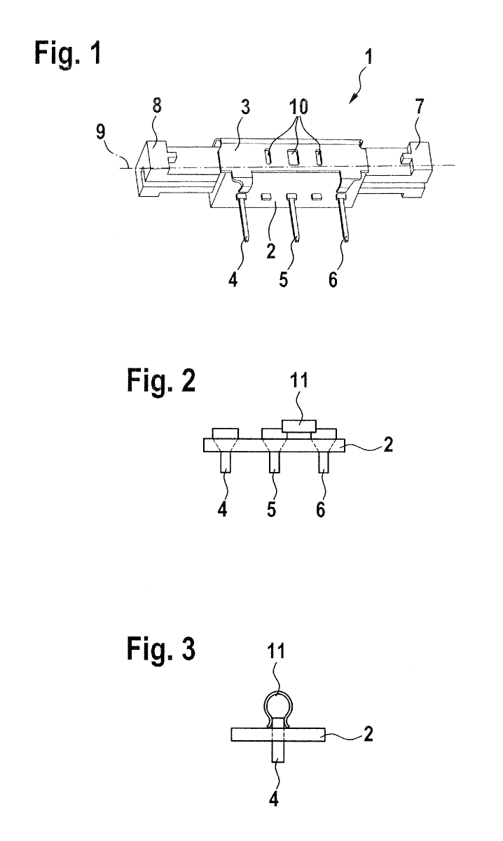

The electric slide switch 1 shown in FIG. 1 has a base plate 2 and a housing 3 secured to the base plate 2; a total of three contact pins 4, 5, and 6 are situated on the base plate 2, extending perpendicular to the plane of the base plate and protruding downward from the base plate 2. The contact pins 4, 5, 6 are to be electrically connected via a contact element 11 (FIGS. 2-4) situated in sliding fashion on the inside of the housing 3; the sliding motion extends along the longitudinal axis 9 of the base plate 2 and housing 3. By means of the contact element 11, it is possible to selectively produce an electrical connection between two respective adjacent contact pins 4 and 5, or 5 and 6.

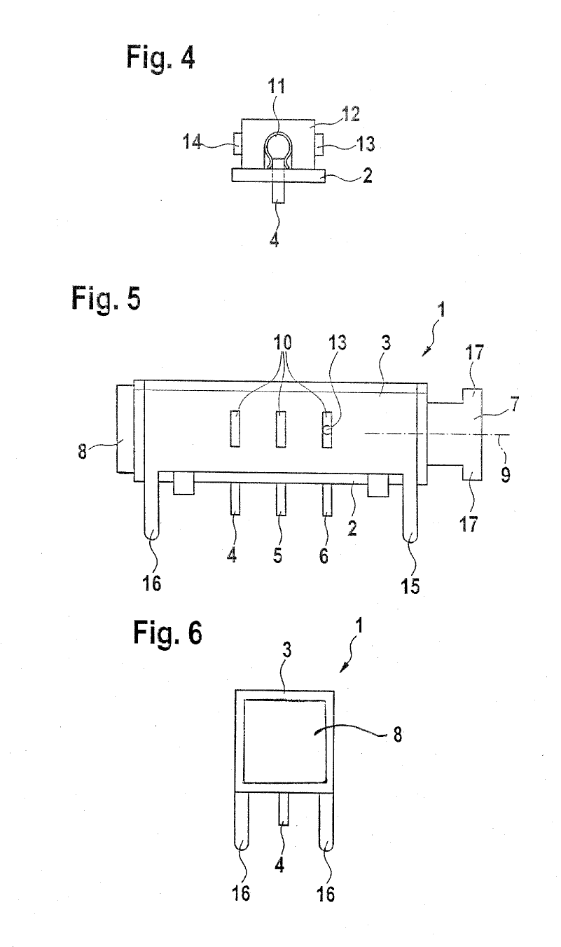

The contact element 11 inside the housing 3 is secured to a slider 12 (FIG. 4) on which actuating components or actuators 7, 8 are situated, which protrude laterally from the housing 3 and are used to execute the sliding motion along the longitudinal axis 9. The exemplary embodiment according to FIG. 1 is provided with two diametrically opposing actuating components 7, 8 protruding from the housing 3.

The side wall of the housing 3 is provided with a total of three detent engagement recesses 10, which reflect various detent-engaged positions that the slider 12 can assume inside the housing. A detent engagement element 13, 14 (FIG. 4), e.g. a detent engagement spring, situated on the slider engages in detent fashion in the detent engagement recesses 10. Each detent engagement recess 10 corresponds to a different detent-engaged position, for example two contact positions for connecting the contact pins 4 and 5; and 5 and 6, respectively, as well as a nonfunctional or out-of-contact position. Detent engagement recesses 10 of this kind are suitably provided in both opposing side walls of the housing 3; detent engagement elements, e.g. detent engagement springs, are situated on both sides of the slider 12 as well and can engage in the recesses 10 in detent fashion.

FIGS. 2 through 4 show the contact element 11, which is situated on the slider 12 (FIG. 4) and together with the slider 12, can execute an axial sliding motion in order to connect different contact pins 4 and 5. The contact element 11, which is embodied for example in the form of a tulip, as shown in FIGS. 2-4, produces an electrical contact between adjacent contact pins.

The opposite sides of the slider 12 are provided with the detent engagement elements 13 and 14, which are embodied for example in the form of detent engagement springs and are embodied to be brought into a detent engagement with the recesses 10 in the housing wall of the housing 3 with the axial sliding motion.

FIGS. 5 and 6 show another exemplary embodiment of an electric slide switch 1. The slide switch 1 is provided with an actuating component 7 at one end of the housing 3 and another actuating component 8 at the opposite end of the housing 3. The slide switch 1 has been slid to the right so that the actuating component 7 is protruding from the housing 3 whereas the other actuating component 8 is contacting the housing 3. To prevent one of the actuating components from being slid too far into the housing, projections 17 oriented laterally, i.e. transversely relative to the longitudinal axis 9 and sliding direction, are formed onto the ends of the actuating components 7, 8 and come into contact with the outside of the housing 3 when the actuating component approaches the housing.

According to an alternative embodiment, an actuating component is provided at only one end of the housing 3. This means that the different contact positions and detent-engaged positions are to be produced solely by actuating the actuating component protruding from one end, i.e. with either a pushing or pulling force, depending on the sliding direction.

FIGS. 5 and 6 also show that the housing 3 is provided with connecting legs 15 and 16 at the respective ends of the housing, whose function is to produce a mechanical connection to another component, in particular for connecting to a circuit board with which an electrical contact is likewise produced by means of the contact pins 4, 5, 6. The connecting legs 15 and 16 are in particular formed integrally onto the housing 3.

FIG. 5 also shows that the detent engagement element 13, which is affixed to the slider 12 in the housing 3, is engaged in detent fashion in one of the detent engagement recesses 10.

The foregoing relates to preferred exemplary embodiments of the invention, it being understood that other variants and embodiments thereof are possible within the spirit and scope of the invention, the latter being defined by the appended claims.

1. An electric slide switch, comprising:
at least two contact pins that are secured to a base plate;
a contact element supported in sliding fashion for electrically connecting the contact pins; the contact element is situated on
a slider connected to an actuating component and when in a contact position, is also situated in a detent-engaged position in which the slider engages in detent fashion with the base plate or with a housing connected to the base plate, the contact elements being situated on the slider, and a movement direction of the slider laying in a connecting line passing through the at least two contact pins, wherein
the actuating component protrudes laterally from the housing in the movement direction of the slider.

2. The slide switch according to claim 1, wherein two detent engagement elements for producing the detent-engaged position are situated on opposite sides of the slider.

3. The slide switch according to claim 2, wherein the detent engagement elements for producing the detent-engaged position are embodied in the form of detent engagement springs.

4. The slide switch according to claim 2, wherein in the detent-engaged position, the detent engagement elements engage in detent fashion in detent engagement recesses provided in the housing.

5. The slide switch according to claim 3, wherein in the detent-engaged position, the detent engagement elements engage in detent fashion in detent engagement recesses provided in the housing.

6. The slide switch according to claim 4, wherein a plurality of detent engagement recesses are situated in the movement direction in the housing.

7. The slide switch according to claim 5, wherein a plurality of detent engagement recesses are situated in the movement direction in the housing.

8. The slide switch according to claim 1, wherein three contact pins are situated in a row and the contact element is embodied to electrically connect two respective adjacent contact pins to each other.

9. The slide switch according to claim 4, wherein three contact pins are situated in a row and the contact element is embodied to electrically connect two respective adjacent contact pins to each other.

10. The slide switch according to claim 5, wherein three contact pins are situated in a row and the contact element is embodied to electrically connect two respective adjacent contact pins to each other.

11. The slide switch according to claim 1, wherein an actuating component protrudes laterally at each end of the housing.

12. The slide switch according to claim 2, wherein an actuating component protrudes laterally at each end of the housing.

13. The slide switch according to claim 3, wherein an actuating component protrudes laterally at each end of the housing.

14. The slide switch according to claim 4, wherein an actuating component protrudes laterally at each end of the housing.

15. The slide switch according to claim 6, wherein an actuating component protrudes laterally at each end of the housing.

16. The slide switch according to claim 8, wherein an actuating component protrudes laterally at each end of the housing.

17. The slide switch according to claim 11, wherein an end stop is provided on the actuating component which end stop comes into contact with the housing when the actuating component is slid into the housing.

18. The slide switch according to claim 16, wherein an end stop is provided on the actuating component which end stop comes into contact with the housing when the actuating component is slid into the housing.

19. The slide switch according to claim 1, wherein connecting legs for producing a mechanical connection to another component are formed onto the housing.

20. The slide switch according to claim 19, wherein the contact pins and connecting legs are situated on a same side of the housing.
